(19) United States
(12) Patent Application Publication
(10) Pub. No.: US 2021/0237514 A1
(43) Pub. Date: Aug. 5, 2021

(54) REINFORCEMENT CORD FOR ELASTOMER PRODUCTS, IN PARTICULAR OF VEHICLE TIRES, AND ELASTOMER PRODUCT

(71) Applicant: Continental Reifen Deutschland GmbH, Hannover (DE)

(72) Inventors: Michael Schunack, Hannover (DE); Thomas Kramer, Herford (DE)

(73) Assignee: Continental Reifen Deutschland GmbH, Hannover (DE)

(21) Appl. No.: 16/972,052

(22) PCT Filed: May 6, 2019
(86) PCT No.: PCT/EP2019/061476

§ 371 Date: Dec. 4, 2020

(30) Foreign Application Priority Data
Jun. 14, 2018 (DE) 10 2018 209 525.6

(51) Int. Cl. B60C 9/00; C08G 63/672; D02G 3/48; D01F 6/62; D02G 3/02

(52) U.S. Cl. CPC B60C 9/0042; C08G 63/672; B60C 9/005; B60C 2009/0092; D01F 6/62; D02G 3/02; D02G 3/48

(57) ABSTRACT

The invention relates to a reinforcement cord for elastomeric products, in particular for pneumatic tires, comprising at least one yarn made of filaments.

The invention further relates to an elastomeric product comprising at least one reinforcement cord.

For protection of the environment and conservation of resources, together with good processing performance, at least one yarn of the reinforcement cord comprises filaments made of polybutylene dicarboxyfuranoate (PBF), where the PBF has been produced entirely or at least to some extent from biomass and/or from renewable raw materials.

The invention relates to a reinforcement cord for elastomeric products, in particular for pneumatic tires, comprising at least one yarn made of filaments.

The invention further relates to an elastomeric product comprising at least one reinforcement cord.

Reinforcement cords are provided for reinforcement to many elastomeric products, for example hoses, conveyor belts, drive belts and pneumatic tires. Reinforcement cords consist of one or more yarns twisted together, and are known to the person skilled in the art in a very wide variety of embodiments relating to structure and to material. When two or more yarns are present here, the material can be identical or, as in the case of hybrid cords, there can be at least two different yarns. The yarns are generally composed of many individual filaments (fibers). The form in which the reinforcement cords are used in the elastomeric products is by way of example that of woven fabrics, laid scrims or knitted fabrics, and during the production of the elastomeric products said cords are usually embedded into a rubber mixture.

Reinforcement systems hitherto used in elastomeric products, in particular in carcass plies, bead reinforcers, tire belts or belt bandages of pneumatic tires have on the one hand been textile systems in which the material present is primarily (directly) based on fossil raw materials such as petroleum, examples being PET (polyethyleneterephthalate, aramid and nylon, or hybrid cords made of yarns composed of these. On the other hand, use of non-petroleum-based textile reinforcement systems made of viscose, for example rayon or lyocell, is known.

Many natural fibers, i.e. non-petroleum-based materials, have the disadvantage, as material for reinforcement cords, of lacking a continuous fiber structure and exhibiting great variation of fiber quality.

Use of rayon by way of example as belt bandage in pneumatic tires is moreover rendered difficult by, for example, shortcomings in its shrinkage performance. Other disadvantages of rayon are that it is moisture-sensitive and that the breaking strength of the reinforcement system is reduced by absorption of moisture. The purchase price of rayon is moreover high.

The development activity is being directed toward development and use of environmentally friendly elastomer products which conserve resources and do not use primary fossil raw materials, examples being pneumatic tires, while avoiding any requirement to accept sacrifices in the durability of the resultant products:

DE 102010017107 A1 discloses hybrid cords for, by way of example, carcass plies and/or belt bandages which consist of at least of one yarn made of recycled PET (polyethyleneterephthalate).

EP 2 590 811 A1 discloses multifilament yarns with fibers made of polyamide 10.10, where the two starting monomers 1,10-decamethylenediamine and 1,10-decanedioic acid are obtained from castor oil as renewable raw material. The multifilament yarns can be used as reinforcement systems in pneumatic tires.

EP 2 708 380 A1 describes reinforcement cords for elastomeric products, in particular for tires, in which at least one yarn consists of PET which has been produced entirely or at least to some extent from renewable raw materials.

EP 2 895 648 A1 discloses reinforcement cords for elastomeric products, in particular, for tires, in which at least one yarn consists of PEF (polyethylene furanoate) which has been produced entirely or at least to some extent from biomass and/or from renewable raw materials. However, PEF has a tendency toward rapid crystallization after the procedure of spinning to give a yarn, and therefore the material is sometimes brittle, not amenable to winding and not amenable to drawing. PEF comes into consideration as replacement for PET.

It is thus an object of the present invention to provide a reinforcement cord for elastomeric products, in particular for pneumatic tires, comprising at least one yarn, where said cord represents an alternative to conventional reinforcement cords, can be produced in a sustainable manner, and can be processed successfully without premature embrittlement of the spun material, and comprises materials that are environmentally friendly and conserve resources. The reinforcement cord is moreover intended to exhibit consistent product quality.

The object is achieved in that at least one yarn of the reinforcement cord comprises filaments made of polybutylene dicarboxyfuranoate (PBF), where the PBF has been produced entirely or at least to some extent from biomass and/or from renewable raw materials.

Polybutylene dicarboxyfuranoate (PBF), also termed polybutylene furanoate or poly(butylene 2,5-furanedicarboxylate), is an aliphatic-aromatic polyester which formally is produced via polycondensation of 1,4-butanediol and furane-2,5-dicarboxylic acid.

Use of PBF from biomass and/or from renewable raw materials in the reinforcement cord of the invention for elastomeric products is sustainable and environmentally friendly, and conserves resources. PBF produced entirely or at least to some extent from biomass and/or from renewable raw materials moreover resembles PBF obtained only from fossil raw materials in that it exhibits consistent quality. Consistent product quality can therefore be ensured. The number of methylene units in the diol segment is larger than in PEF and leads to slower crystallization. The material is more amenable to spinning and to wind-up, with no premature embrittlement. It is more amenable to drawing. The mechanical and thermal properties of PBF are comparable with those of petroleum-based PBT (polybutyleneterephthalate). The melting point of PBF is about 172° C.

For the purposes of the invention, the expression “PBF entirely or at least to some extent made of renewable raw materials” means that—irrespective of the energy source used during production of the PBF—the material present therein has been produced entirely or at least to some extent from biomass and/or from renewable raw materials. PBF consisting entirely or at least to some extent of biomass and/or renewable raw materials is not obtained solely from, or completely excludes (comprises 0% by weight of), fossil raw materials such as petroleum.

As is known to the person skilled in the art, the proportion of the biobased materials in the PBF, i.e. the proportion derived from renewable raw materials and/or from biomass, can be determined in accordance with ASTM D6866 (method C-14).

For the purposes of the invention, the term biomass means the entirety of all organic material that is formed via growth and metabolism of animals, plants or microorganisms.

For the purposes of the invention, the expression renewable raw materials means biogenic resources derived from aquaculture and from agricultural and forestry sources. The expression renewable raw materials therefore excludes fossil sources accessible by virtue of degradation, an example being petroleum.

In the case of PBF, firstly the underlying monomer furan-2,5-dicarboxylic acid can be produced from biomass and/or from renewable materials, for example cellulose, and secondly the second monomer 1,4-butanediol can also be produced from biomass and/or from renewable raw materials. By way of example, 1,4-butanediol can be produced by a biotechnological method via fermentation of sugar.

It is preferable that both monomers are produced from biomass and/or from renewable raw materials.

It is moreover conceivable that one of the two monomers or both monomers take(s) the form of mixture, i.e. that the monomer(s) then derive(s) to some extent from biomass and/or from renewable raw materials and to some extent from petroleum.

Within the yarns of a reinforcement cord, there can be filaments present made of different materials. In an advantageous further development of the invention, however, all filaments consist of at least of one yarn made of polybutylene dicarboxyfuranoate (PBF). Such yarns can easily be spun and twisted.

The reinforcement cord can consist of a twisted, continuous multifilament yarn. It is also possible, however, that the reinforcement cord comprises at least one further yarn made of filaments, where the yarns have undergone end-twisting t ogether. There are by way of example possible cord structures in which two (2 construction) or three (3 construction) yarns have undergone end-twisting to give a reinforcement cord.

The, or the further, yarn(s) can consist of filaments of different material. If yarns made of different material are present within the reinforcement cord, this is what is known as a hybrid cord.

The material for the further yarn can preferably be nonmetallic material, examples being polyester, aliphatic and aromatic polyamides, aramid, polyetherketone, polyketone, polyethylenenaphthalate, viscose, natural fibers or glass fibers. The properties of the reinforcement cord can be adjusted via suitable selection of material.

In a preferred further development of the invention, the at least one further yarn of the reinforcement cord consists of filaments made of polyamide, of a polyester other than polybutylene dicarboxyfuranoate (PBF), or aramid, of polyketone, or preferably of manufactured fibers made of natural polymers or of natural fibers. Manufactured fibers made of natural polymers, or natural fibers, clearly have the advantage that the entire reinforcement cord is based on materials that are environmentally friendly and conserve resources and that, for example, are based on crude oil.

In order to obtain better shrinkage performance of the reinforcement cord, it is preferable in another advantageous further development of the invention that said cord consists of at least one yarn made of polybutylene dicarboxyfuranoate (PBF) and of at least one further yarn made of a polyamide (PA). This is in particular advantageous for the use of this hybrid cord in the belt bandage of a car tire.

The further yarn particularly preferably consists of PA 6.6- and/or PA 6 filaments and/or PA 10.10 filaments and/or PA 10.12 filaments and/or PA PACM 12 filaments. It is very particularly preferable that the yarn consists of PA 6.6 filaments.

In order to increase its modulus, the reinforcement cord consists of at least one yarn made of polybutylene dicarboxyfuranoate (PBF) and of at least one further yarn made of aramid. This is in particular advantageous for the use of this hybrid cord in the belt bandage of UHP (ultra high-performance) tires.

In order to obtain a stable reinforcement cord substantially without shrinkage, said cord consists of at least one yarn made of polybutylene dicarboxyfuranoate (PBF) and of at least one further yarn made of rayon. This is in particular advantageous for the use of this hybrid cord in the carcass of car tires and for the high-velocity performance of car tires.

In an alternative to the abovementioned hybrid cords, the reinforcement cord can also be a cord in which all yarns consist of polybutylene dicarboxyfuranoate (PBF) filaments. This reinforcement cord is easy to produce and is particularly environmentally friendly, because it derives solely from renewable raw materials.

The linear density of the yarn(s) in the reinforcement cord is preferably 200 to 5000 dtex. The yarn(s) has/have therefore preferably been twisted with a twist value of 100 to 600 t/m, preferably 100 to 550 t/m, particularly preferably 200 to 550 t/m. Such reinforcement cords are easy to produce and can by way of example be used as reinforcement systems in pneumatic tires.

If the reinforcement cord is a cord made of a plurality of yarns, these yarns have undergone end-twisting preferably with a twist value of 100 to 600 t/m, preferably 100 to 550 t/m, particularly preferably 200 to 550 t/m. It is particularly preferable that the twist number is approximately the same for the first-twisting of the yarn and for the end-twisting of the cord; it is preferable here that the twist directions of yarns and cord are opposite.

In order to obtain adequate fatigue resistance of the reinforcement cords, it is advantageous that the twist factor a of each yarn or of the reinforcement cord is between 100 and 300, preferably between 150 and 250, where the twist factor a is calculated according to the following formula: α=twist [t/m]×(linear density [tex]/1000)^{1/2}.

In order to ensure reliable adhesion of textile reinforcement systems to the rubber, it is advantageous to provide an adhesive impregnation system to the reinforcement cord of the invention, e.g. by using an RFL dip in the 1- or 2-bath process.

The reinforcement cord of the invention can be used in a very wide variety of elastomeric products, for example drive belts, conveyor belts, hoses or air springs.

The elastomer product of the invention is preferably a pneumatic tire. Pneumatic tires are mass-produced products where partial replacement of conventional reinforcement cords by biobased reinforcement cords leads to a particularly large effect on the conservation of resources.

It is preferable that the pneumatic tire comprises the reinforcement cord in the carcass ply and/or in at least one bracing ply and/or as bead reinforcer and/or in the belt bandage. It is particularly preferable that the pneumatic tire comprises the reinforcement cord in the carcass ply and/or in the belt bandage.

1-13. (canceled)

14. A reinforcement cord for elastomeric products, in particular for pneumatic tires, comprising at least one yarn made of filaments, Wherein the at least one yarn of the reinforcement cord comprises filaments made of polybutylene dicarboxyfuranoate (PBF), and wherein the PBF has been produced entirely or at least to some extent from biomass and/or from renewable raw materials.

15. The reinforcement cord as claimed in claim 14, wherein the PBF has been produced entirely from biomass and/or from renewable raw materials.

16. The reinforcement cord as claimed in claim 14, wherein all filaments of the at least of one yarn consist of polybutylene dicarboxyfuranoate (PBF).

17. The reinforcement cord as claimed in claim 14 further comprising at least one further yarn made of filaments, wherein the at least one yarn and the at least one further yarn have undergone end-twisting together.

18. The reinforcement cord as claimed in claim 17, wherein the at least one further yarn consists of filaments made of a nonmetallic material.

19. The reinforcement cord as claimed in claim 17, wherein the at least one further yarn consists of filaments made of polyamide, of a polyester other than polybutylene dicarboxyfuranoate (PBF), of aramid, of polyketone, of manufactured fibers made of natural polymers, or of natural fibers.

20. The reinforcement cord as claimed in claim 14, wherein all yarns of the reinforcement cord consist of polybutylene dicarboxyffiranoate (PBF) filaments.

21. The reinforcement cord as claimed in claim 14, wherein the linear density of the yarn(s) is 200 and 5000 dtex.

22. The reinforcement cord as claimed in claim 14, wherein the twist factor a of each yarn or of the reinforcement cord is between 100 and 300, and wherein the twist factor a is calculated according to the following formula:
α=twist [t/m]×(linear density [tex]/1000)^{1/2}.

23. An elastomeric product comprising the at least one reinforcement cord as claimed in claims 14.

24. The elastomeric product as claimed in claim 23, wherein the elastomeric product is a drive belt, a conveyor belt, a hose or an air spring.

25. The elastomeric product as claimed in claim 23, wherein the elastomeric product is a pneumatic tire.

26. The elastomeric product as claimed in claim 25, wherein the pneumatic tire comprises the at least one reinforcement cord as claimed in claim 14 in a carcass ply and/or in at least one bracing ply and/or as a bead reinforcer and/or in a belt bandage.
